(19) United States
(12) Patent Application Publication
(10) Pub. No.: US 2026/0330129 A1
(43) Pub. Date: Oct. 22, 2026

(54) DOWNLOADING, UPLOADING AND EDITING REGIONS OF PDF DOCUMENTS

(71) Applicant: Adobe Inc., San Jose, CA (US)

(72) Inventors: Sujata Das, Saratoga, CA (US); Leonard Rosenthol, Margate City, NJ (US); Jie-Wei Li, San Jose, CA (US)

(73) Assignee: Adobe Inc., San Jose, CA (US)

(21) Appl. No.: 19/186,439

(22) Filed: Apr. 22, 2025

(51) Int. Cl. G06F 40/174

(52) U.S. Cl. CPC G06F 40/174

(57) ABSTRACT

In implementation of techniques for downloading, uploading, and editing regions of PDF documents, a computing device implements an editing system to receive a command to perform an edit to an object depicted on a document. The editing system identifies a region of the document that corresponds to the object and downloads the region of the document from storage. By performing the edit to the object in the region of the document, the editing system generates an edited region of the document and incorporates the edited region into the document.

### BACKGROUND

Portable Document Format (PDF) is a universally compatible file format that preserves layout, fonts, images, and formatting of a document across different devices and operating systems. PDF documents are used for sharing and printing documents because they maintain a consistent appearance for viewing across the different devices and operating platforms. In some examples, PDF documents contain text, images, links, forms, or multimedia elements. PDF documents are also capable of being password-protected, digitally signed, and annotated, making them useful for official documents, e-books, reports, and legal papers. Cloud native PDF documents are an alternative representation of PDF documents that are stored in a cloud-based storage environment or other distributed environment in some examples. However, editing PDF documents results in computational inefficiencies and increased power consumption in real world scenarios.

### SUMMARY

Techniques and systems for downloading, uploading, and editing regions of PDF documents are described. In an example, an editing system receives a command to perform an edit to an object depicted on a document. For example, the document is a Portable Document Format (PDF) document. In some examples, the object includes text or a defined area for filling a form included on the document.

The editing system identifies a region of the document that corresponds to the object and downloads the region of the document from storage. Some examples further comprise dividing content depicted on the document into regions based on comparing different visual attributes on the document. In some examples, the region of the document is a page of a multi-page document.

By performing the edit to the object in the region of the document, the editing system generates an edited region of the document. The editing system then incorporates the edited region into the document. Some examples further comprise converting the document to a cloud native PDF document before incorporating the edited region into the document. For example, incorporating the edited region into the document involves uploading the edited region of the document to the storage. Additionally, in some examples identifying the region of the document that corresponds to the object, downloading the region of the document from the storage, generating the edited region of the document, and incorporating the edited region into the document are performed in real-time as the command to edit the object depicted on the document is received.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for downloading, uploading, and editing regions of PDF documents as described herein.

FIG. 2 depicts a system in an example implementation showing operation of a mesh progression module for downloading, uploading, and editing regions of PDF documents.

FIG. 3 depicts an example of a user interface for editing a PDF document.

FIG. 4 depicts an example of receiving a command to perform an edit to an object depicted on the PDF document.

FIG. 5 depicts an example of identifying a region of the PDF document that corresponds to the object and downloading the region of the PDF document from storage.

FIG. 6 depicts an example of generating an edited region of the PDF document by performing the edit to the object in the region of the PDF document and incorporating the edited region into the PDF document.

FIG. 7 depicts an example of a diagram illustrating stages of downloading, uploading, and editing regions of PDF documents.

FIG. 8 depicts a procedure in an example implementation of downloading, uploading, and editing regions of PDF documents.

FIG. 9 depicts a procedure in an additional example implementation of downloading, uploading, and editing regions of PDF documents.

FIG. 10 depicts a flow diagram depicting an algorithm as a step-by-step procedure for training a machine learning model according to aspects of the present disclosure.

FIG. 11 illustrates an example system including various components of an example device that can be implemented as any type of computing device as described and/or utilized with reference to FIGS. 1-11 to implement embodiments of the techniques described herein.

### DETAILED DESCRIPTION

### Overview

A Portable Document Format (PDF) document is a type of document with preserved layout, fonts, images, and formatting for consistent viewing across different devices and operating systems. Because PDF documents maintain a consistent appearance for viewing across the different devices and operating systems, they are used for sharing and printing a variety of visual media. Additionally, PDF documents contain text, images, links, forms, or multimedia elements in some examples and are used for a variety of applications, including official documents, e-books, reports, and legal papers. Cloud native PDF documents are representations of PDF documents that are useful for collaboration in a distributed environment where multiple computers perform operations related to a shared document, including in a cloud-based storage environment. For example, the cloud native PDF documents are accessible from the cloud-based storage environment or other environment by a variety of client devices.

Conventional cloud-based PDF editing techniques involve downloading a PDF document from cloud-based storage to edit a portion of the PDF document and then uploading the PDF document back to the cloud-based storage after editing. However, this is slow, uses a large amount of resources, and makes collaboration involving edits involving on PDF document difficult. This is because the PDF document is downloaded in its entirety to perform a given edit to a relatively smaller portion of the PDF document.

Techniques and systems are described for downloading, uploading, and editing regions of PDF documents that overcome these limitations. For instance, content of a PDF document is divided into different regions, and a region involved with performing an edit (e.g., a line of text being edited) is downloaded to edit. Incremental changes involving the regions are then saved to the cloud-based storage to perform the edit. This is faster and uses fewer resources than the conventional cloud-based PDF editing techniques because a smaller portion of a PDF document is downloaded, edited, and uploaded rather than downloading, editing, and uploading the PDF document as a whole.

An editing system begins in this example by receiving a command to edit a PDF document that is stored in cloud-based storage. The edit, for instance, involves a specific object or portion of the PDF document to edit. Examples of the edit include adding or removing characters from a body of text, adding or removing an image, changing font size, color, or style, or making other changes to the PDF document.

The PDF document in this example is a cloud native PDF document, which is designed for creation, storage, sharing, and collaboration in a cloud rather than a static, locally stored file. In some examples, the PDF document is saved in the cloud-based environment as a cloud native PDF document. The editing system for example, is configured to convert the PDF document into a cloud native PDF document.

To efficiently download portions of the PDF document that are relevant to the edit, the editing system divides content of the PDF document into different regions that are visually distinct. In an example, one region is a block of text of the PDF document, while a second region an image on the PDF document, and a third region is an additional block of text of the PDF document. In some examples, the editing system divides the content of the PDF document into different regions by leveraging a machine learning model trained to identify visual characteristics of objects depicted on the PDF document. In other examples, the editing system references a PDF manifest or other metadata related to the PDF document to identify the different regions.

The editing system then identifies a region of the PDF document that corresponds to the object that is the subject of the edit. For instance, the region is an area of visual content depicted on the PDF document that includes the target of the edit, including the block of text, the image, or the additional block of text. In other examples, the region is a page of the PDF document. For instance, the region is the page of a multi-page PDF document that is being edited.

After identifying the region of the PDF document, the editing system downloads the region of the PDF document from the cloud-based storage. The editing system then generates an edited region for the PDF document by performing the edit to the object in the region of the PDF document. For example, the editing system edits the block of text, the image, or the additional block of text as instructed by the indication of the edit. The editing system then uploads and saves the edited region to the PDF document to the cloud-based storage, forming an edited PDF document. This is performed in real-time as the command to edit the PDF document is received, and the editing system generates an output including the edited PDF document for presentation in the user interface.

Downloading, uploading, and editing regions of PDF documents in this manner overcomes the limitations of conventional cloud-based PDF editing techniques that involve downloading and re-uploading a PDF document as a whole to cloud-based storage before and after editing. For example, dividing content of the PDF document into different regions, downloading the regions involved with performing the edit, and then uploading and saving incremental changes involving the regions to the cloud-based storage to perform the edit reduces the amount of content that is downloaded from the cloud-based storage. This is faster, uses fewer resources, and facilitates easier collaboration for multiple-user editing than the conventional cloud-based PDF editing techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

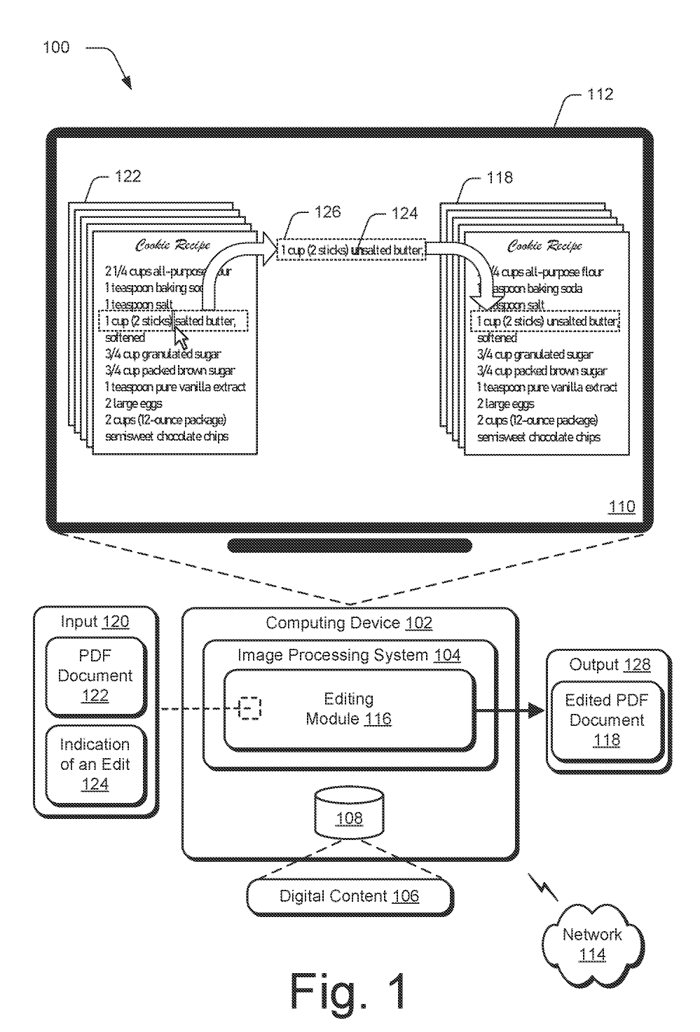

FIG. 1 is an illustration of a digital medium environment 100 in an example implementation that is operable to employ techniques and systems for downloading, uploading, and editing regions of Portable Document Format (PDF) documents described herein. The illustrated digital medium environment 100 includes a computing device 102, which is configurable in a variety of ways.

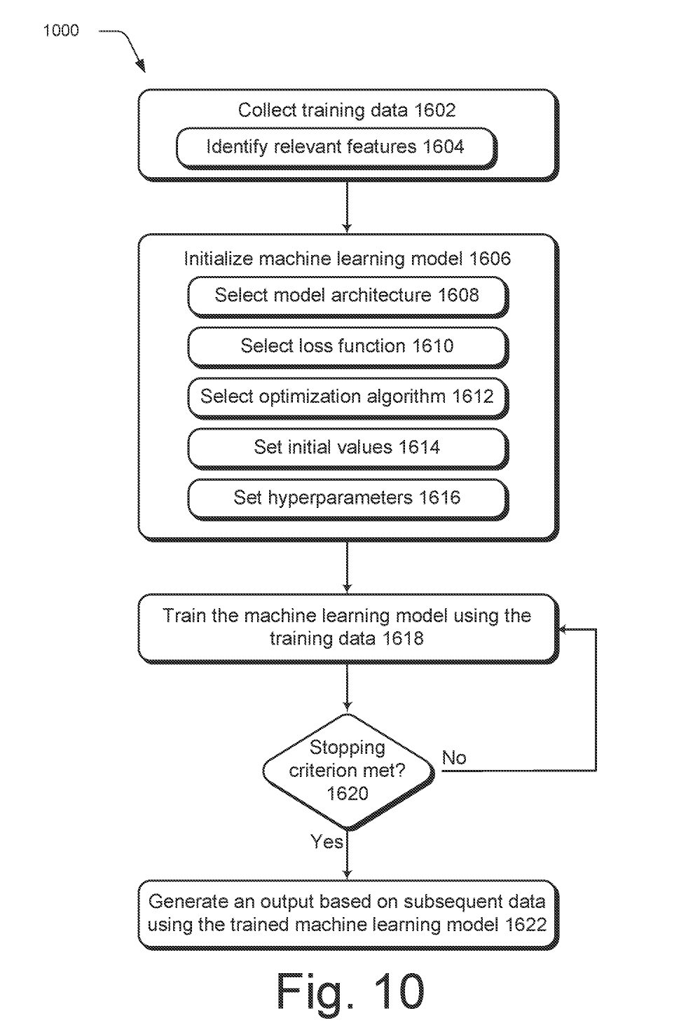

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes an editing module 116 which is illustrated as incorporated by the image processing system 104 to process the digital content 106. In some examples, the editing module 116 is separate from the image processing system 104 such as in an example in which the editing module 116 is available via the network 114.

The editing module 116 is configured to generate an edited PDF document 118. For example, the editing module 116 first receives an input 120 referencing a PDF document 122 and an indication of an edit 124 to the PDF document 122. The PDF document 122 is a file type configured to maintain formatting, fonts, images, and layout of visual data. In this example, the PDF document 122 is housed in storage, for instance, a cloud-based environment, and is accessible by the editing module 116. The indication of the edit 124 indicates a specific object or portion of the PDF document 122 to edit. Examples of the edit 124 include adding or removing characters from a body of text, adding or removing an image, changing font size, color, or style, or making other changes to the PDF document 122.

As shown in this example, the input 120 involves a PDF document 122, which is a multi-page PDF document featuring a recipe. An indication of an edit 124 is received, which in this example involves an input to edit text in the PDF document 122 of the recipe to change “salted butter” in the ingredient list to “unsalted butter.”

After receiving the PDF document 122 and the indication of the edit 124, the editing module 116 divides content of the PDF document 122 into different regions that are visually distinct. In an example, one region is a block of text of the PDF document 122, while a second region is an image, and a third region is an additional block of text. The editing module 116 then identifies a region 126 of the PDF document 122 that corresponds to the object that is the subject of the edit 124. In some examples, the region 126 is an area of content of the PDF document 122, including the block of text, the image, or the additional block of text. In other examples, the region 126 is a page of the PDF document 122, which is a multi-page PDF document. In this example, for instance, the object being edited is text inside the region 126, which is a line of text in the ingredient list.

The editing module 116 downloads the region 126 of the PDF document 122 from storage. For instance, the PDF document 122 is a cloud native PDF in this example, which is stored in cloud-based storage, and the region 126 is currently being edited. In contrast to conventional techniques, for instance, the editing module 116 downloads the region 126 of the PDF document 122 rather than an entire PDF document.

After the editing module 116 downloads the region 126, the editing module 116 generates an edited region of the PDF document 122 by performing the edit 124 to the object in the region 126 of the PDF document 122. For instance, the editing module 116 edits the block of text, the image, or the additional block of text, as instructed by the indication of the edit 124. The editing module 116 then uploads the edited region for incorporation into the PDF document 122 in the cloud-based storage, forming an edited PDF document 118.

The editing module 116 then generates an output 128 including the edited PDF document 118, further examples of which are described in the following sections and shown in corresponding figures. As depicted in this example, the edited PDF document 118 includes the edited region including the term “unsalted butter” in the ingredient list. The edited PDF document 118 is available for further interaction, viewing, or editing.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Downloading, Uploading, and Editing Regions of PDF Documents

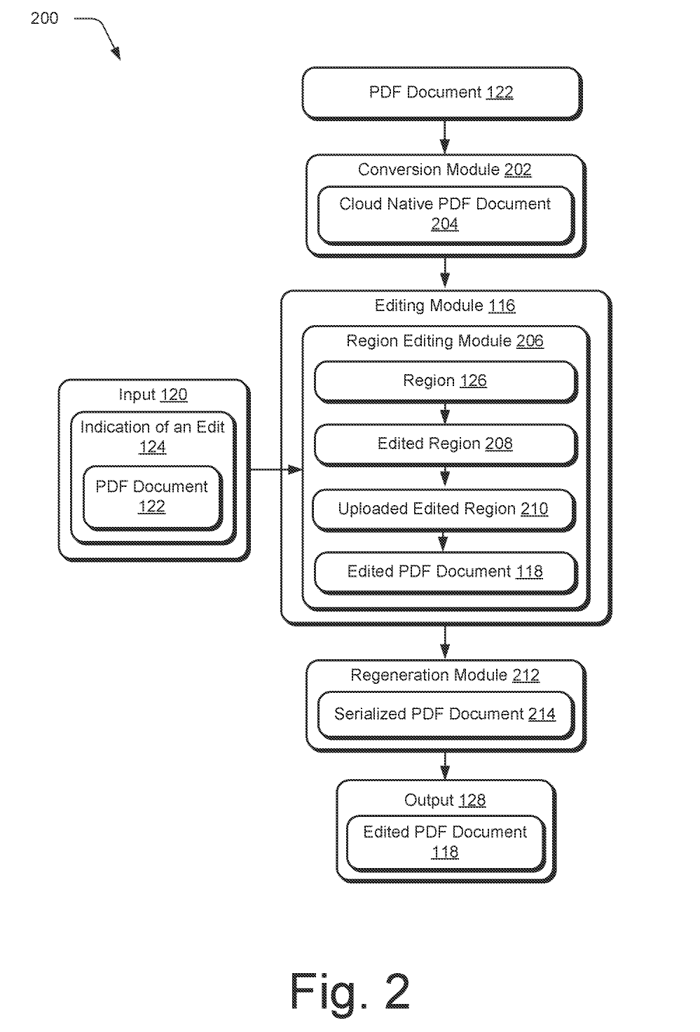

FIG. 2 depicts a system 200 in an example implementation showing operation of the editing module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-11.

To begin in this example, a conversion module 202 receives a PDF document 122. As discussed above, the PDF document 122 is a file type configured to maintain visual data in a constant form for viewing, editing, and distribution, including formatting, fonts, images, and layout.

The conversion module 202 is configured to convert the PDF document 122 into a cloud native PDF document 204. The cloud native PDF document 204 is designed for creation, storage, sharing, and collaboration in a cloud rather than a static, locally stored file. In some examples, the PDF document 122 is saved in the cloud-based environment as a cloud native PDF document 204. The cloud native PDF document 204 facilitates collaborative workflows involving access by multiple different devices or accounts associated with different users. Additionally, viewing the cloud native PDF document 204 saved in the cloud-based environment is fast because the cloud native PDF document 204 is viewed on a page-by-page basis by downloading a specific page being viewed.

The editing module 116 receives an input 120 including an indication of an edit 124 to the PDF document 122. For instance, the indication of the edit 124 indicates a specific object or portion of the PDF document 122 that is actively being edited. Examples of the edit 124 include adding or removing characters from a body of text, adding or removing an image, changing font size, color, or style, cropping the PDF document 122, or making other changes to the PDF document 122. In an example involving collaborative editing with multiple devices, a first indication of an edit is received, indicating an edit performed using a first device by a first user, and a second indication of an edit is received, indicating an edit performed using a second device by a second user. For instance, the first indication of the edit involves page 3, while the second indication of the edit involves page 5. In other examples, however, the edits performed with the multiple devices involve a common page, section, or region of the PDF document.

The editing module 116 includes a region editing module 206. The region editing module 206 divides content of the PDF document 122 into different regions that are visually distinct. In this example, one region is a block of text of the PDF document 122, while a second region is an image, and a third region is an additional block of text. To do this, the region editing module 206 leverages a machine learning model trained to identify visual characteristics of objects depicted on the PDF document 122. In other examples, the region editing module 206 references a PDF manifest or other metadata related to the PDF document 122 to identify the different regions.

The editing module 116 then identifies a region 126 of the PDF document 122 that corresponds to the object that is the subject of the edit 124. For instance, the region 126 is an area of visual content depicted on the PDF document 122 that includes the subject of the edit, including the block of text, the image, or the additional block of text. In other examples, the region 126 is a page of the PDF document 122, which is a multi-page PDF document. For instance, the region 126 is the page of the PDF document 122 that is currently being edited.

Because the cloud native PDF document 204 corresponds to the PDF document 122, the region editing module 206 downloads the region 126 from the cloud native PDF document 204 from storage. For instance, the cloud native PDF document 204 is stored in cloud-based storage in this example, and the region 126 is currently being edited. In contrast to conventional techniques, for instance, the editing module 116 downloads the region 126 of the cloud native PDF document 204, rather than an entire PDF document. In the example involving the collaborative editing with the multiple devices above, the editing module 116 downloads page 3 to the first device and downloads page 5 to the second device for editing.

The region editing module 206 then generates an edited region 208 for the PDF document 122 by performing the edit 124 to the object in the region 126 of the cloud native PDF document 204. For instance, the editing module 116 edits the block of text, the image, of the additional block of text as instructed by the indication of the edit 124.

The editing module 116 then uploads the edited region 208 to the storage, for instance, from the cloud storage, resulting in an uploaded editing region 210. Once uploaded, the uploaded editing region 210 is incorporated into the cloud native PDF document 204 to produce an edited PDF document 118. The edited PDF document 118, for instance, includes content of the cloud native PDF document 204 that is updated according to the edit 124, with the edited region 208 replacing the region 126. In the example involving the collaborative editing with the multiple devices above, the editing module 116 uploads and saves the first edit to page 3 and uploads and saves the second edit to page 5, based on the first indication of the edit and the second indication of the edit.

In some examples, the editing module 116 also includes a regeneration module 212. The regeneration module 212 is configured to convert the edited PDF document 118 from the cloud native PDF document 204 into a serialized PDF document 214. The serialized PDF document 214 is configured for sequential parsing or streaming. For example, individual pages of the serialized PDF document 214 are capable of being retrieved. Because downloading, uploading, and editing regions of PDF documents is performed in relation to a cloud native PDF document 204, various editing operations including commenting, editing page content, form filling, changing page order, rotating pages, cropping pages, reordering pages, and inserting pages are localized to specific regions of pages of the cloud native PDF document 204 being edited, rather than the PDF document 122 as a whole. Therefore, edits are collaboratively performed using multiple devices without downloading and uploading the PDF document 122 by the multiple devices or users. In contrast, conventional PDF editing techniques involve downloading and uploading the PDF document 122 by multiple devices or users, resulting in overwritten changes.

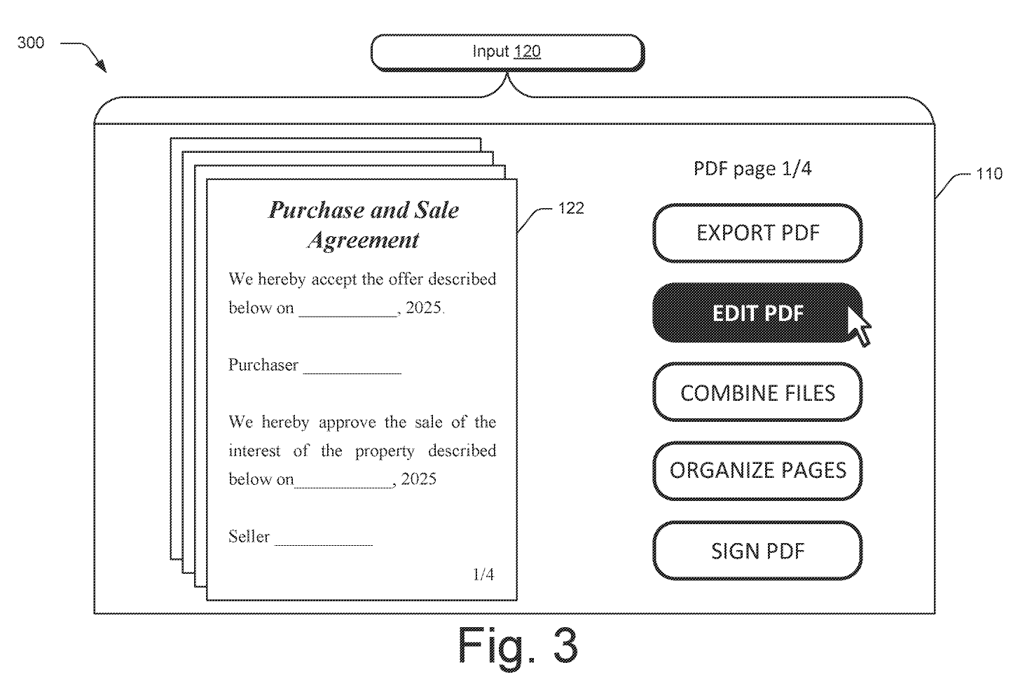

FIGS. 3-7 depict stages of downloading, uploading, and editing regions of PDF documents. In some examples, the stages depicted in these figures are performed in a different order than described below.

FIG. 3 depicts an example 300 of a user interface for editing a PDF document. As illustrated, a user interface 110 depicts a PDF document 122. The PDF document 122 is a type of file that preserves layouts, fonts, images, and formatting of a document for viewing across different devices and operating systems. For instance, the PDF document 122 is configured to be platform-independent, resulting in consistency regardless of how or where the PDF document 122 is viewed. Unlike other document formats, the PDF document 122 maintains a fixed layout, making it ideal for official documents, forms, e-books, and reports. In some examples, the PDF document 122 contains text, images, hyperlinks, interactive elements, embedded fonts, and multimedia, including videos and audio. Additionally, in some examples the PDF document 122 incorporates security features, including password protection, encryption, and digital signatures to ensure document authenticity and restricted access. In this example, the PDF document 122 is a Purchase and Sale Agreement, which includes four pages.

In some examples, the PDF document 122 includes a manifest, which is a structured representation of metadata, content, and components associated with the PDF document 122. In some examples, the manifest includes document metadata, including the title, author, creation date, and version, along with details about the file structure, including objects, fonts, images, annotations, bookmarks, and form fields. Additionally, in some examples the manifest describes embedded resources in the PDF document 122, including attachments, multimedia elements, and external links, as well as content indexing and extraction details, including text structure and accessibility features.

The PDF document 122 includes other structural elements in some examples, which define its composition, behavior, and metadata. A metadata dictionary stores descriptive details, including title, author, keywords, and creation date. Additionally, at the core of PDF document 122 in some examples is the document catalog, which acts as the top-level structure, referencing components of the PDF document 122 including pages, outlines, named destinations, and interactive forms. A cross-reference table and object streams map object positions for efficient access and compression, while a trailer dictionary links to the document catalog and cross-reference table, enabling fast parsing. In some examples, the PDF document 122 also features a page tree structure that organizes pages and their attributes, optimizing rendering and navigation. For interactivity, the PDF document 122 includes annotations and interactive elements including comments, form fields, and digital signatures. Additionally, in some examples, the PDF document 122 also contains embedded files and attachments for incorporating multimedia elements including videos and audio into the PDF document 122.

The user interface 110 also depicts a variety of buttons for collecting input for operational commands involving the PDF document 122. The buttons in this example include “export PDF, “edit PDF,” “combine files,” “organize pages,” and “sign PDF.” Other examples of operations performed on PDF documents include viewing, reading, creating, merging, deleting, and converting PDF documents. While these examples involve editing visual elements of PDF documents, other examples of operations performed on PDF documents involve editing metadata, bookmarks, and attachments of PDF documents. As illustrated in this example, the editing module 116 receives an input 120 including a command to “edit PDF” via the button presented in the user interface 110. Alternatively, the editing module 116 receives a command to “organize pages,” or other option related to the PDF document 122.

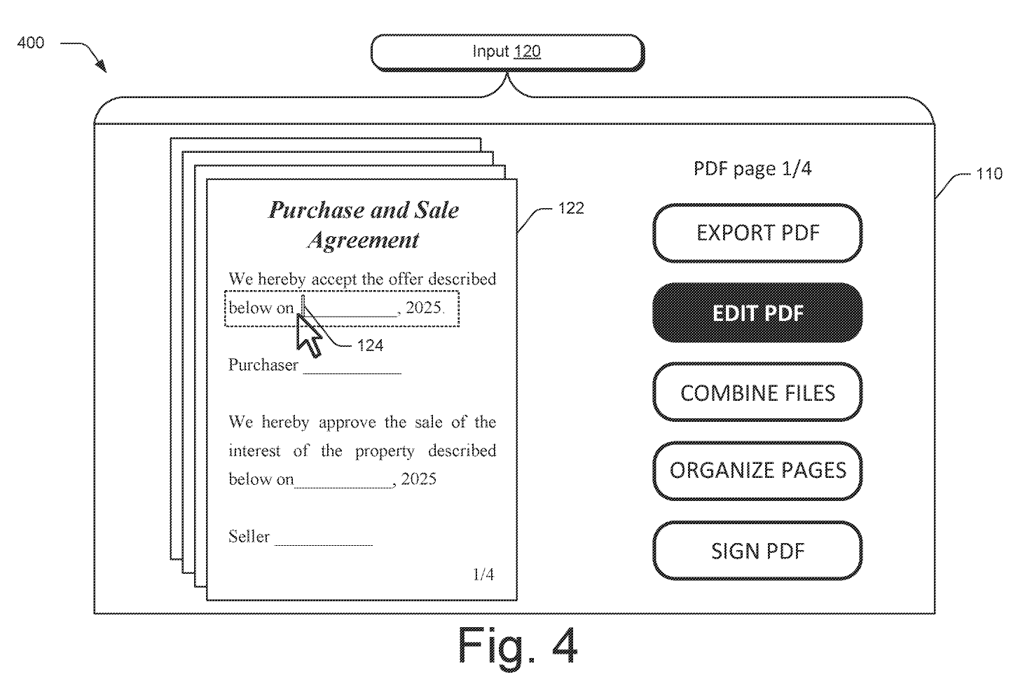

FIG. 4 depicts an example 400 of receiving a command to perform an edit to an object depicted on the PDF document. FIG. 4 is a continuation of the example described in FIG. 3. As shown in this example, the editing module 116 receives an input 120 including an indication of an edit 124 to the object depicted on the PDF document 122. Here, the object of the PDF document 122 that is being edited is a line of text of the Purchase and Sale Agreement that says “below on______, 2025,” which is a blank space for filling in a date. The indication of the edit 124 that is being initiated in this example involves filling in the date. Other examples of edits to the PDF document 122 include adding text, removing text, adding images, removing images, organizing pages, and changing visual attributes of the PDF document 122, including font styles, font color, or font size.

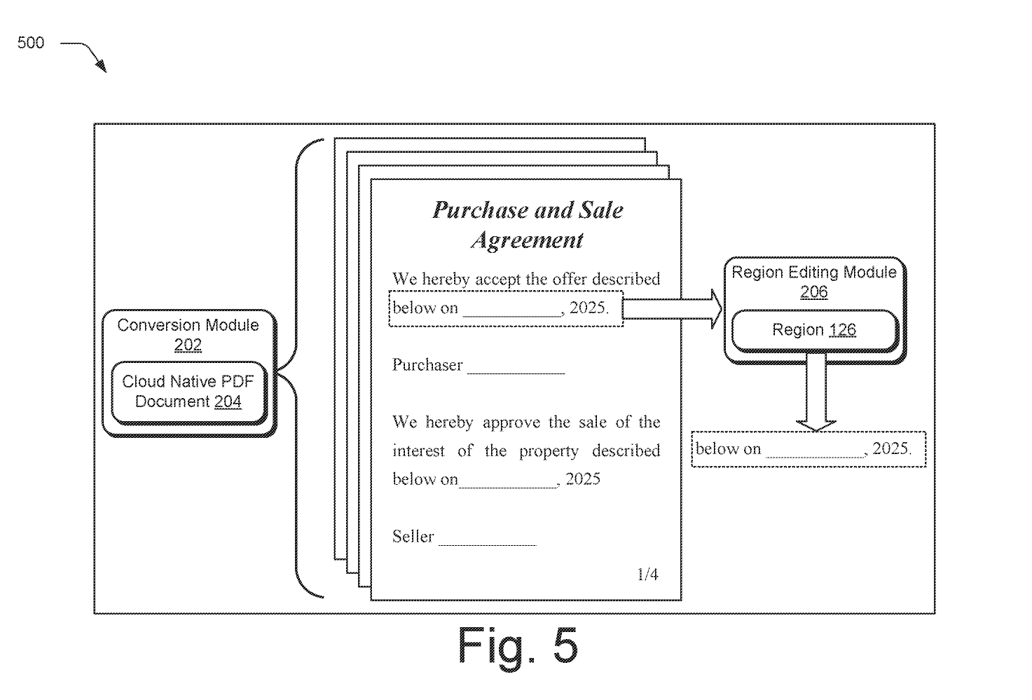

FIG. 5 depicts an example 500 of identifying a region of the PDF document that corresponds to the object and downloading the region of the PDF document from storage. FIG. 5 is a continuation of the example described in FIG. 4. After the editing module 116 receives an input 120 including an indication of an edit 124 to the object depicted on the PDF document 122, the editing module 116 uses the region editing module 206 to identify the region 126 so that a smaller portion of the PDF document 122 (or cloud native PDF document 204) is downloaded for editing.

To begin, the conversion module 202 identifies a region 126 of the PDF document 122 corresponding to the object of the edit 124. In this example, the PDF document 122 is a cloud native PDF document 204. For instance, the cloud native PDF document 204 is stored in a cloud-based storage environment. In some examples, the conversion module 202 converts the PDF document 122 to the cloud native PDF document 204.

To identify the region 126 in some examples, the region editing module 206 divides the cloud native PDF document 204 into separate regions. To do this, the region editing module 206 leverages a machine learning model in some examples to segment different visual content regions in the cloud native PDF document 204 by analyzing the document’s structure, layout, and visual elements. The machine learning model is trained to identify various types of content, including text blocks, images, tables, and diagrams. The machine learning model learns from labeled datasets where different regions are annotated, and identifies the various regions based on a manifest or metadata of the PDF document 122 or the cloud native PDF document 204 in some examples. Additionally, in some examples the machine learning model is trained based on image recognition. Although this example contemplates usage of a machine learning model, other examples do not involve a machine learning model to divide the cloud native PDF document 204 into separate regions. For example, identifying the region 126 in some examples involves comparing different visual attributes of the PDF document 122.

In some examples, this involves traversing the PDF document 122 and decomposing its COS objects, representing native object serialization format, into logical COS object groups and saving them as different COS component files with a “cos” extension. The COS component files correspond to individual pages of logical groups, including Structure Tree, name Tree, AcroForms, or Bookmarks. The editing module 116 creates additional components in some examples that hold non-COS data in PDF format, including XMP metadata, embedded files, images, and other components in native format. A cross-reference table component for the represented as a JSON file. The COS table entries in the cross-reference table in a cloud native PDF contains an additional entry that handles its component file when compared to its PDF representation.

After identifying the region 126, the region editing module 206 downloads the region 126 for editing. To download the region 126 in this example, the region editing module 206 requests a portion of a file corresponding to the cloud native PDF document 204, as a particular page or section, rather than the cloud native PDF document 204 in its entirety. For example, the server hosting the cloud native PDF document 204 supports the requests, enabling partial downloads by retrieving byte ranges specified by the request. Components of the cloud native PDF document 204 are organized in a folder hierarchy with a manifest file in JSON format that describes names, types, relationships, and paths of the components, allowing parsing of the cloud native PDF document 204.

As illustrated in this example, the region editing module 206 identifies the region 126, which is a line of text of the Purchase and Sale Agreement that says “below on______, 2025,” which is a blank space for filling in a date. The region editing module 206, for instance, corresponds to the indication of the edit 124, as the region 126 identifies the region 126 live in real-time as the user causes the edit 124.

Some examples involve the region 126 as a whole page or a range of pages. In an example involving organizing pages of the PDF document 122, for instance, the region editing module 206 identifies the region 126, which includes the pages being organized. For example, a command to organized pages is received, as pages 2 and 3 are switched in order. Accordingly, the region editing module 206 identifies the region 126 including pages 2 and 3. While these examples involve editing visual elements of the PDF document 122, other examples of operations performed on the PDF document 122 involve editing metadata, bookmarks, and attachments of the PDF document 122.

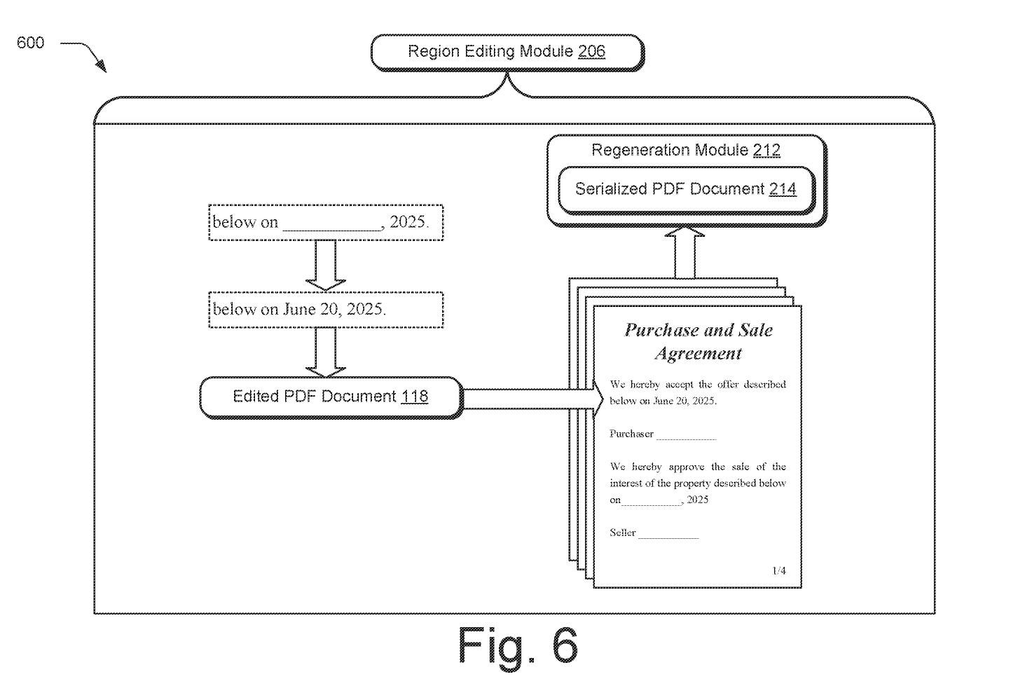

FIG. 6 depicts an example 600 of generating an edited region of the PDF document by performing the edit to the object in the region of the PDF document and incorporating the edited region into the PDF document. FIG. 6 is a continuation of the example described in FIG. 5. After the editing module 116 uses the region editing module 206 to identify the region 126, the editing module 116 performs the edit 124 to the region 126 and incorporates the region 126 into the PDF document 122, for example, the cloud native PDF document 204.

As illustrated, the indication of the edit 124 includes adding the date “June 20” to the region 126 of the line of text. In real-time as the indication of the edit 124 is received, the editing module 116 incorporates the date “June 20” into the region 126 of the line of text. The edit 124 is incrementally saved to the cloud-based storage, resulting in an edited PDF document 118, as well as saved in an update specific directory along with an updated manifest file. Because this is performed on the back-end of operations (e.g., at the cloud-based storage), from a user viewpoint, the editing module 116 performs the edit 124 to the PDF document 122 in the user interface 110, without additional steps or apparent indications that identifying the region 126 and saving the region is occurring. Further, because the changes to the cloud native PDF document 204 are incremental, remote clients viewing the cloud native PDF document 204 are able to view the cloud native PDF document 204 without impact regarding full refresh of the cloud native PDF document 204.

In some examples, editing to the region 126 and incorporating the region 126 into the PDF document 122 involves replacing the region 126 of the PDF document 122 with an edited region 208. For instance, in this example the region 126 says “below on______, 2025,” which is replaced by the edited region 208, which says “below on June 20, 2025,” according to the input 120 from the user with the indication of the edit 124.

The editing module 116 then uploads the edited region 208 to the storage, for instance, to the cloud storage. Once uploaded, the edited region 208 is incorporated into the cloud native PDF document 204 to produce an edited PDF document 118. The edited PDF document 118, for instance, includes content of the cloud native PDF document 204 that is updated according to the edit 124, with the edited region 208 replacing the edit 124.

Further, in this example a regeneration module 212 converts the edited PDF document 118 into a serialized PDF document 214. This involves restructuring the edited PDF document 118 so that the document is compatible with being downloaded and used as a self-contained file. For instance, given an example in which the edited PDF document 118 is a cloud native PDF document 204, the edited PDF document 118 is flattened and structured as a standalone file, which involves resolving byte-range access by fetching parts of the edited PDF document 118, embedding external resources including fonts and images, and consolidating interactive elements into a static format. In other examples, the edited PDF document 118 is linearized for optimized rendering. The regeneration module 212 then encodes the edited PDF document 118 with standard PDF compression while preserving metadata and security settings, resulting in a self-contained file that can be stored, shared regardless of availability of cloud infrastructure.

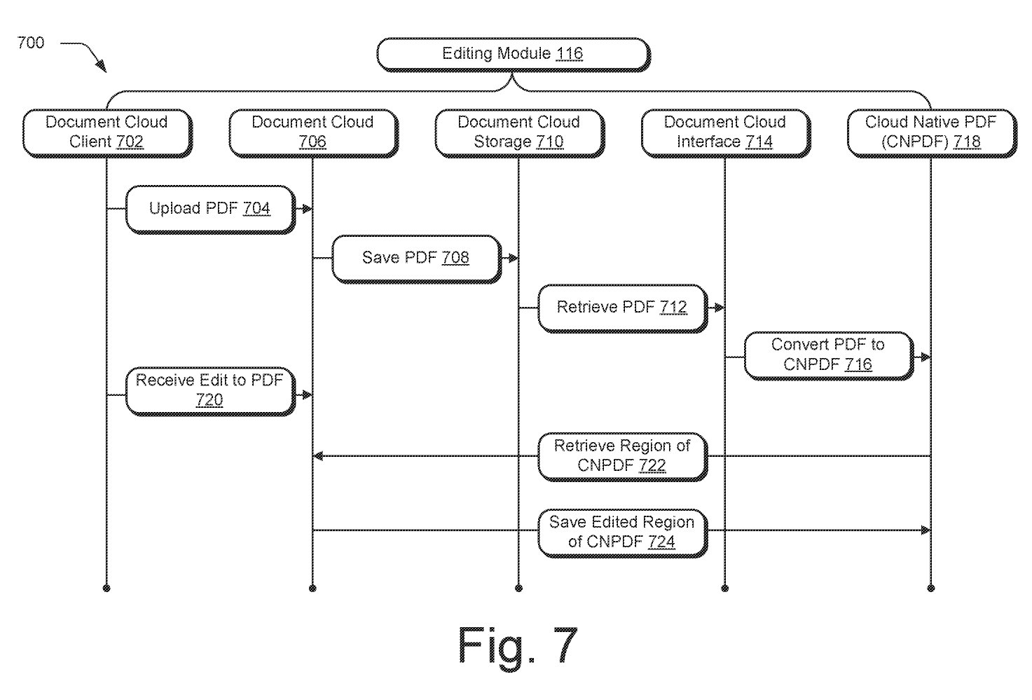

FIG. 7 depicts an example 700 of a diagram illustrating stages of downloading, uploading, and editing regions of PDF documents. An editing module 116 includes a document cloud client 702, which involves a user interface 110 for interaction with a PDF document 122 in some examples. The document cloud client 702, for instance, involves software or an application that connects to a document cloud 706, storage, access, editing, and management of PDF documents online.

The document cloud client 702 is configured to perform operations to upload a PDF 704 to the document cloud 706. The document cloud 706 represents an online platform that provides cloud-based storage, management, and processing of PDF documents. The document cloud 708 is configured to facilitate saving the PDF 704 on document cloud storage 710.

For example, the document cloud storage 710 is related to the document cloud 708 and refers to an online service that allows for storage, access, and management of PDF documents on remote cloud servers instead of local devices. The document cloud storage 710, for instance, is configured to facilitate retrieving the PDF 712 from a document cloud interface 714. The document cloud interface 714 is a user-facing platform or API that allows for interaction with the document cloud storage 710 and also enables for uploading, storage, editing, management, and sharing of documents within a cloud environment of the document cloud storage 710. The document cloud interface 714 is configured to facilitate a conversion of the PDF 712 to a cloud native PDF 718, for instance, stored in the document cloud storage 710. The cloud native PDF 718 a type of PDF document designed to be created, edited, managed, and stored directly in document cloud storage 710, rather than being generated and modified on a local device. This optimizes the cloud native PDF 718 for online collaboration, automation, and integration with cloud-based workflows.

For editing the cloud native PDF 718 in this example, the document cloud client 702 receives an edit to the PDF 720. The edit specifies a change to an object depicted on the PDF 712, which corresponds to the cloud native PDF 718. After identifying a region of the cloud native PDF 718 that corresponds to the edit, the region of the cloud native PDF 718 is retrieved by the document cloud 706 from the document cloud storage 710. The edit is then performed on the region, resulting in an edited region. Once edited, an edited region of the cloud native PDF 718 is saved to the cloud storage for later access.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-7.

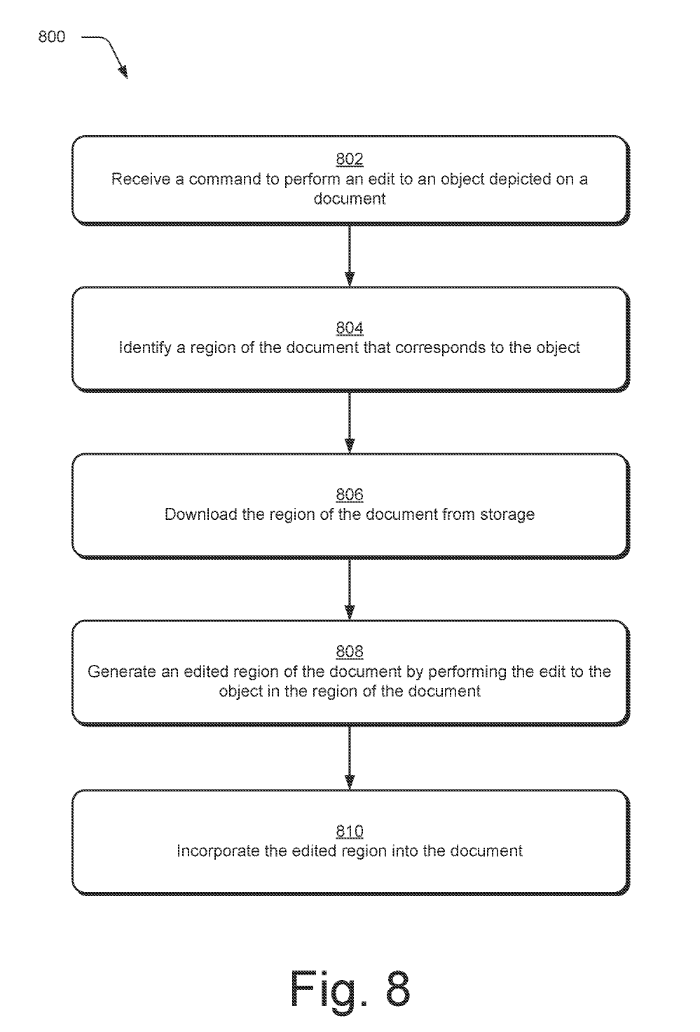

FIG. 8 depicts a procedure 800 in an example implementation of downloading, uploading, and editing regions of PDF documents. At block 802 a command is received to perform an edit 124 to an object depicted on a document. For example, the document is a Portable Document Format (PDF) document 122. In some examples, the object includes text. In other examples, the object includes a defined area for filling a form included on the document.

At block 804, a region 126 of the document is identified that corresponds to the object. Some examples further comprise dividing content depicted on the document into regions based on comparing different visual attributes on the document.

At block 806, the region 126 of the document is downloaded from storage. In some examples, the region 126 of the document is a page of a multi-page document.

At block 808, an edited region 208 of the document is generated by performing the edit 124 to the object in the region 126 of the document. For example, the object depicted on the document is edited according to the command to perform the edit 124.

At block 810, the edited region 208 is incorporated into the document. Some examples further comprise converting the document to a cloud native PDF document 204 before incorporating the edited region 208 into the document. Additionally, some examples further comprise serializing the cloud native PDF document 204 into an updated PDF document for saving in the storage. In some examples, the identifying the region 126 of the document that corresponds to the object, the downloading the region 126 of the document from the storage, the generating the edited region 208 of the document, and the incorporating the edited region 208 into the document are performed in real-time as the command to edit 124 the object depicted on the document is received. Additionally, in some examples incorporating the edited region 208 into the document involves uploading the edited region 208 of the document to the storage.

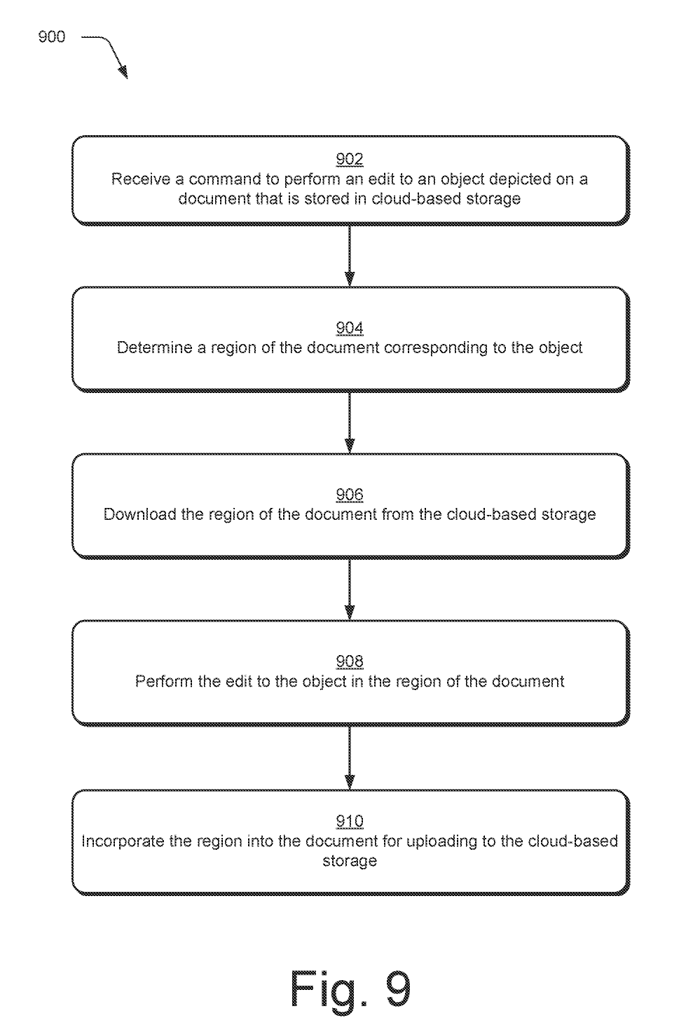

FIG. 9 depicts a procedure 900 in an additional example implementation of downloading, uploading, and editing regions of PDF documents. At block 902, a region 126 of a document is identified based on a received command to perform an edit 124 to the document. In an example, the document is a Portable Document Format (PDF) document. For example, the received command to edit 124 the document involves at least one of editing text, organizing pages, adding pages, removing pages, rotating pages, or cropping pages. Additionally or alternatively, the received command to edit 124 the document involves editing a defined area for filling a form included on the document.

At block 904, the region 126 of the document is downloaded from storage. For example, the region 126 of the document is retrieved from cloud-based storage. Alternatively, the document is stored in local storage of a storage device. In an example, the region 126 of the document is a page of a multi-page document.

At block 906, an edited region 208 of the document is generated by performing the edit 124 to the region 126 of the document. In some examples, the region 126 of the document is replaced by the edited region 208 of the document.

At block 908, an edited document is presented by incorporating the edited region 208 into the document. Some examples are further configured for performing operations comprising converting the document to a cloud native PDF document 204 before incorporating the edited region 208 into the document. Additionally, some examples are further configured to perform operations comprising serializing the cloud native PDF document 204 into an updated PDF document for saving in the storage.

### Training: Machine Learning

FIG. 10 is a flow diagram depicting an algorithm as a step-by-step procedure 1000 in an example implementation of operations performable for training a machine-learning model. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (block 1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set (block 1016) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model.

### Example System and Device

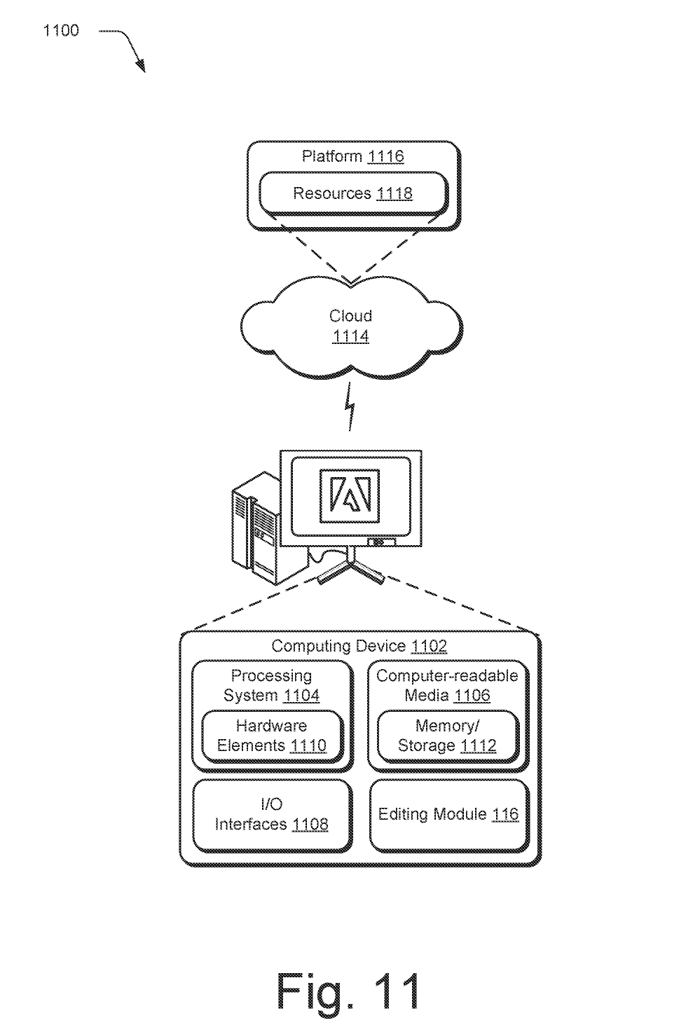

FIG. 11 illustrates an example system generally at 1100 that includes an example computing device 1102 that is representative of one or more computing systems and/or devices that implement the various techniques described herein. This is illustrated through inclusion of the editing module 116. The computing device 1102 is configurable, for example, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices and/or processing systems 1104) to implement techniques, modules, and examples described herein.

The techniques described herein are supported by various configurations of the computing device 1102 and are not limited to the specific examples of the techniques described herein. This functionality is also implementable through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized when computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

What is claimed is:

1. A method comprising:
receiving, by a processing device, a command to perform an edit to an object depicted on a document;
identifying, by the processing device, a region of the document that corresponds to the object;
downloading, by the processing device, the region of the document from storage;
generating, by the processing device, an edited region of the document by performing the edit to the object in the region of the document; and
incorporating, by the processing device, the edited region into the document.

2. The method of claim 1, wherein the document is a Portable Document Format (PDF) document.

3. The method of claim 2, further comprising converting the document to a cloud native PDF document before incorporating the edited region into the document.

4. The method of claim 1, wherein the incorporating the edited region into the document involves uploading the edited region of the document to the storage.

5. The method of claim 1, further comprising dividing content depicted on the document into regions based on comparing different visual attributes on the document.

6. The method of claim 1, wherein the object includes text.

7. The method of claim 1, wherein the object includes a defined area for filling a form included on the document.

8. The method of claim 1, wherein the identifying the region of the document that corresponds to the object, the downloading the region of the document from the storage, the generating the edited region of the document, and the incorporating the edited region into the document are performed in real-time as the command to edit the object depicted on the document is received.

9. The method of claim 1, wherein the region of the document is a page of a multi-page document.

10. A system comprising:
a memory component; and
a processing device coupled to the memory component, the processing device to perform operations comprising:
identifying a region of a document based on a received command to perform an edit to the document;
downloading the region of the document from storage;
generating an edited region of the document by performing the edit to the region of the document; and
presenting an edited document by incorporating the edited region into the document.

11. The system of claim 10, wherein the document is a Portable Document Format (PDF) document.

12. The system of claim 11, further configured to perform operations comprising converting the document to a cloud native PDF document before incorporating the edited region into the document.

13. The system of claim 12, further configured to perform operations comprising serializing the cloud native PDF document into an updated PDF document for saving in the storage.

14. The system of claim 10, wherein the received command to edit the document involves at least one of editing text, organizing pages, adding pages, removing pages, rotating pages, or cropping pages.

15. The system of claim 10, wherein the received command to edit the document involves editing a defined area for filling a form included on the document.

16. The system of claim 10, wherein the region of the document is a page of a multi-page document.

17. A non-transitory computer-readable storage medium storing executable instructions, which when executed by a processing device, cause the processing device to perform operations comprising:
receiving a command to perform an edit to an object depicted on a document that is stored in cloud-based storage;
determining a region of the document corresponding to the object;
downloading the region of the document from the cloud-based storage;
performing the edit to the object in the region of the document; and
incorporating the region into the document for uploading to the cloud-based storage.

18. The non-transitory computer-readable storage medium of claim 17, wherein the document is a Portable Document Format (PDF) document.

19. The non-transitory computer-readable storage medium of claim 17, wherein the object includes at least one of text or a defined area for filling a form included on the document.

20. The non-transitory computer-readable storage medium of claim 17, wherein the region of the document is a page of a multi-page document.
